(19) United States
(12) Patent Application Publication
(10) Pub. No.: US 2006/0040047 A1
(43) Pub. Date: Feb. 23, 2006

(54) Method of manufacturing an optical film

(75) Inventors: Kuang Rong Lee, Chen City (TW); Hung Yuang Lin, Chen City (TW); Chien Chih Wang, Chen City (TW); Bor Ping Wang, Chen City (TW)

Correspondence Address: BRUCE H. TROXELL;SUITE 1404, 5205 LEESBURG PIKE, FALLS CHURCH, VA, 22041, US

(73) Assignee: Optimax Technology Corporation

(21) Appl. No.: 10/991,523

(22) Filed: Nov. 19, 2004

(30) Foreign Application Priority Data
Aug. 20, 2004 (TW) 93125061

(51) Int. Cl. B05D 5/06; B29C 45/00; B29C 39/14; B29C 55/02; B29C 71/02

(52) U.S. Cl. 427/162; 264/328.1; 264/216; 264/234; 264/288.4

(57) ABSTRACT

Disclosed is a method of manufacturing an optical film, in which a transparent cycloolefin copolymer (COC) material is used as a raw material thereof and solved in a solvent to constitute a solution for forming the optical film. The thus formed optical film may have optical characteristics similar to those of prior-art optical film. Therefore, a retardation film or a protective film may be manufactured using cheaper and more accessible raw materials.

### FIELD OF THE INVENTION

The present invention is related to an optical film, and more particularly to an optical film with a reduced thickness.

### BACKGROUND OF THE INVENTION

Nowadays, many different multi-functional films, such as anti-glare film, EMI shielding film, polarizer, transparent plastic plate acted as supporting layer of polarizer, retardation film and light reflecting film, etc., had been invented and pasted onto the surface of liquid crystal displays (LCDs) for beautifying the color and brightness of images shown on the same. Therefore, these multi-functional films are become indispensable accessories for the LCDs.

However, some multi-functional films are made of materials that are scarce and expensive. Taking the transparent plastic plate, made of material such as triacetyl cellulose (TAC), as an example, since the transparent plastic plate is often being attached onto the top and bottom of a polarizer, it is usually required for the transparent plastic plate to have the characteristics of high transparency, optical isotropy, flawless surface, high heat endurance and wet resistance, high light transmission and high harness, low mold shrinkage with respect to different temperatures and humidity, easy to process, and so on. Accordingly, such optical films may provide sufficient strength and considerable protective effect upon heat and humidity when they are used as the protection sheets for the polarizers. In addition to the protective effects, these transparent plastic plates may also act as support layer for the polarizer. Since transparent plastic plate acted as supporting layer of polarizer is required to have the abovementioned characteristics while using the same for providing efficient support and protect to a polarizer, the materials eligible to be used for making the transparent plastic plate is scarce and usually is expensive.

Taking the retardation film (which may be a stretched polymer film) as another example, it is usually required for the retardation film to have the characteristics of high transparency, proper optical anisotropy, flawless surface, high heat and wet resistance, high light transmission and high harness, low mold shrinkage with respect to different temperatures and humidity, easy to process, and so on, such that the retardation film can compensate any phase variation of liquid crystal cells and thus improve viewing angle of the LCDs.

Similarly, the phase variations of the liquid crystal cells may be efficiently compensated only when the retardation films have the abovementioned characteristics, so that the materials eligible to be used for making the retardation film is scarce and usually is expensive.

An alternative retardation film made of liquid-crystal polymer (LCP) or liquid-crystal (LC), which is formed by coating disc-shaped or bar-shape liquid crystal on a substrate, is capable of providing a more accurate optical compensation, a higher contrast and a wider viewing angle. However, the retardation film not only has the disadvantages of scarce and expensive raw material, but also suffers by the complex manufacturing process of making the same.

In view of the above description, the present invention provides a method of manufacturing an optical film capable of using a more accessible and inexpensive raw material to manufacture the optical film.

### SUMMARY OF THE INVENTION

It is the primary object of the present invention to provide a protective film made of a raw material which is relatively easy to access and lower cost. To achieve the object, the present invention provides a method of manufacturing an optical film, comprising the steps of: selecting a cycloolefin copolymer (COC) as the raw material for the optical film; providing a solvent for solving the COC therein to form a solution; and forming a protective film by using the solution.

In a preferred embodiment, the solvent is substantially a methylbenzene-based nonpolar organic solvent.

In another preferred embodiment of the invention, the method further comprises a step of: subjecting the solution to a stability test for determining whether the solution is proper for forming the protective film; if the solution passes the stability test, the solution is proper for forming the protective film; otherwise, the solution is not proper.

As to the process of forming the protective film using the solution, the protective film may be formed by injection molding or by coating the solution on a flat surface using a scraper.

In addition, while using the method of manufacturing an optical film according to the present invention to manufacture a retardation film instead of the foregoing protective film, the method further comprises the step of: drying the protective film; heating the dried protective film to a glass transition temperature; and stretching the heated protective film to form the retardation film.

### BRIEF DESCRIPTION OF THE DRAWINGS

FIG. 1 is a flowchart of a method of manufacturing an optical film according to a preferred embodiment of the present invention.

FIG. 2 is a table of stability test according to a preferred embodiment according to the present invention.

FIG. 3 is a table of stability test according to another preferred embodiment according to the present invention.

FIG. 4 is a table illustrating differences between a retardation film formed by solution casting according to the present invention and the retardation film of prior art.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

To achieve the objects as mentioned above, the present invention uses a cycloolefin copolymer (COC) resin to replace the materials used to form the protective films of prior art, such as TAC, and the materials used to form retardation film of prior art, such as TAC and cycloolefin polymer (COP) (e.g. ZEONOR of ZEON Corp. and ARTON of JSR Corp.), that the COC is relatively more accessible and cheaper than TAC and COP.

The COC is generally being used as the material forming a substrate of an optical disc or an optical lens. Therefore, while using the COC as the raw material in the method of manufacturing a an optical film, such as protective film and retardation film, the manufacturing process of using the COC for making an optical film inevitably different from that for manufacturing the substrate of an optical disc or an optical lens.

Generally, melt forming is the conventional manufacturing process adopted while using at least two COCs of different compositions for forming the substrate of an optical disc or optical lens. That is, in the case of forming a substrate of an optical disc or optical lens by melt blending, at least two COCs is first melted and blended, and then the blended material is subject to a thermoplastic processing to form the substrate as mentioned. In addition, an elastomer such as SBS, SEBS, SEPS and the like may be provided in the melt blending process to be melted and blended with the at least two COCs so that the substrate of the optical disc or the optical lens formed by the thermoplastic processing may have better tenacity.

However, since the formation of the substrate of the optical disc or optical lens requires the melt blending or the thermoplastic processing, the COCs are apt to deterioration, such as yellowing. Therefore, it was suggested that an anti-oxidant or stabilizer is added to the COCs for stabilizing the mixture of the COCs. However, the optical characteristics of the COC mixture may possibly be impaired.

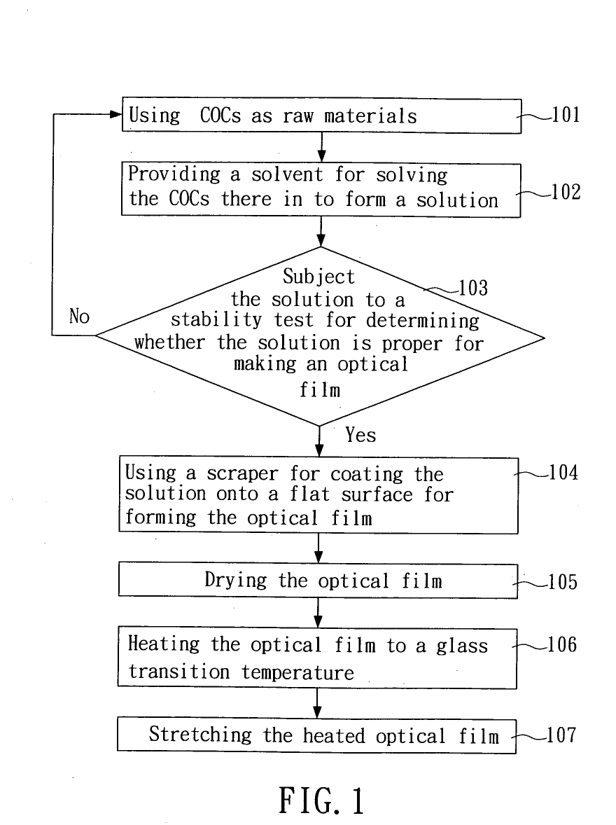

Responsive to the above problems, the present invention provides a method of manufacturing an optical film and a flowchart of a preferred embodiment thereof is illustrated in FIG. 1. The flow starts at step 101, where a COC material are selected as a raw material, and such COC material may be a single COC or a hybrid of several different COCs, and then the flow proceeds to step 102. In step 102, a solvent having capability of solving the selected COC material therein is provided and the candidates for this solvent may be methylbenzene, dichloromethane, cyclohexane and the like. Also in step 102, the selected COC is solved in the above solvent to form a solution and then the flow proceeds to step 103.

In step 103, as the solution having the COC solved therein is formed, the solution is subject to a stability test to determine whether the solution is proper for forming the optical film as desired; if the solution is determined to be proper, the flow proceeds to step 104; otherwise the flow goes back to step 101. In step 104, the optical film is formed using the solution by injection molding or by coating the solution on a flat surface with a scraper.

The optical film formed in step 104 may be used as a protective film functioning as, for example, a support material of a polarizer. Further, the protective film formed according to the above description may be subject to successive processes to form a compensating film such as a retardation film.

For forming a retardation film or the like, the flow then proceeds from step 104 to step 105. In step 105, the optical film formed in step 104 is dried, and then the flow proceeds to step 106. In step 106, the optical film is heated to a glass transition temperature (Tg), and then the flow proceeds to step 107. Finally, in step 107, the heated optical film is stretched to form a retardation film or the like. It is to be noted that the process of the stretching may determine the refractive index of the formed retardation film.

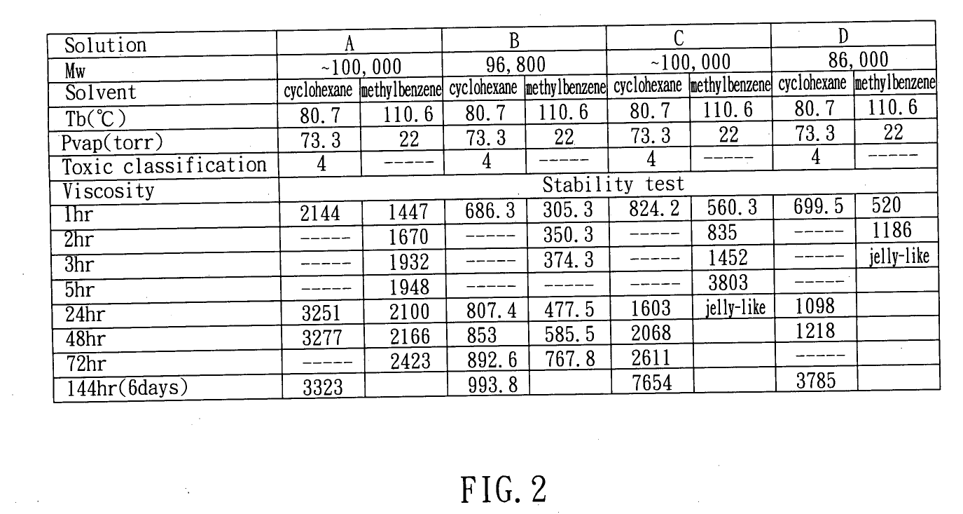

Referring to FIG. 2, which is a table of stability test according to a preferred embodiment according to the present invention. As seen in FIG. 2, solutions having the COCs of different compositions solved in methylbenzene are labeled as A, B, C, D and the like. Among these labeled solutions, the A and B solutions are still stable after about 144 hours. The D and C solutions respectively becomes unstable after 3 hours and 24 hours since the methylbenzene of the solution gets exceedingly viscous and becomes jelly-like. Therefore, after the solutions are subjected to the stability tests, the D and C solutions are generally discarded and the B and A solutions are otherwise selected as proper for forming an optical film.

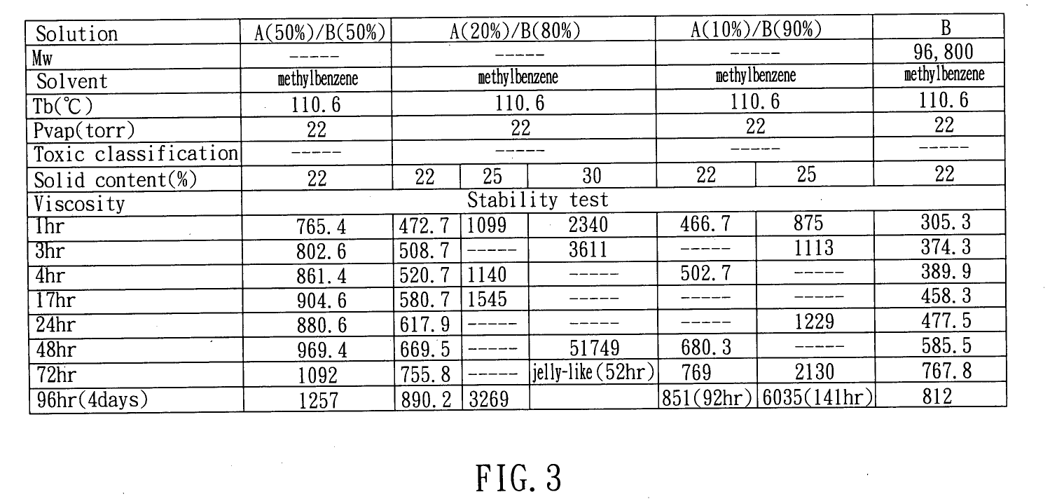

Referring to FIG. 3, which is a table of stability test according to another preferred embodiment according to the present invention. As seen in FIG. 3, the A and B solutions mentioned in FIG. 2 are blended in specific different proportions to act as the solution for the formation of the desired optical film. In this case, a preferred combination of the the A and B solutions may be obtained with respect to heat and mechanical characteristics.

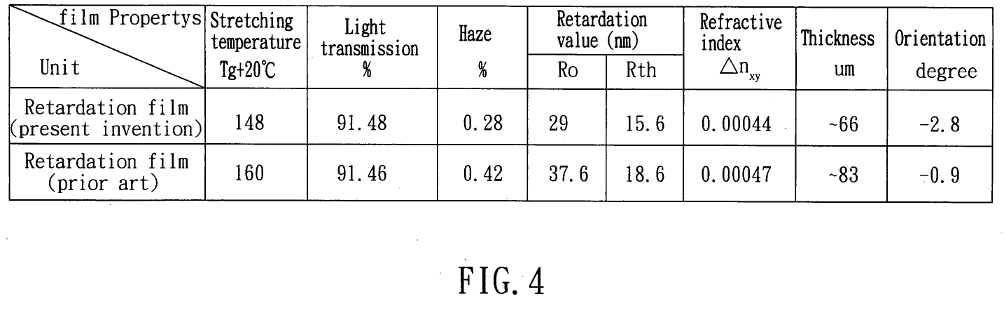

FIG. 4 is a table illustrating differences between a retardation film formed by solution casting according to the present invention and the retardation film of prior art. According to the differences highlighted in FIG. 4, a retardation film formed by blending the A solution (10%) and the B solution (90%) has characteristics, such as light transmission, haze, refractive index, etc., similar to those of the prior retardation film.

In conclusion, the method of manufacturing an optical film use a cheaper and more accessible COC material to form an optical film by solution casting, that the formed optical film with optical characteristics approximate to those of the prior-art optical film may be obtained. Therefore, the protective film and retardation film according to the present invention may be manufactured under the conditions that the raw material is easier to be obtained and the cost thereof is reduced.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method of manufacturing an optical film, comprising the steps of:
using a cycloolefin copolymer (COC) material as a raw material for the optical film;
providing a solvent for solving the COC material therein to form a solution; and
forming a protective film using the solution.

2. The method as recited in claim 1, wherein the solvent is an organic solvent.

3. The method as recited in claim 2, wherein the solvent is methylbenzene.

4. The method as recited in claim 2, wherein the solvent is dichloromethane.

5. The method as recited in claim 2, wherein the solvent is cyclohexane.

6. The method as recited in claim 1, further comprising:
subjecting the solution to a stability test;
wherein, the solution is suitable to be used for forming the protective film while the solution passes the stability test; and the solution is discarded from forming the protective film while the solution fails in the stability test.

7. The method as recited in claim 1, further comprising:
forming the protective film by injection molding of the solution.

8. The method as recited in claim 1, further comprising:
coating the solution on a flat surface by a scraper to form the protective film.

9. The method as recited in claim 1, further comprising:
drying the protective film to form a retardation film.

10. The method as recited in claim 9, further comprising:
heating the dried protective film to a glass transition temperature.

11. The method as recited in claim 10, further comprising:
stretching the heated protective film to form the retardation film.

12. The method as recited in claim 11, wherein the stretching is controlled by specific conditions for obtaining the retardation film having a predetermined refractive index.

13. The method as recited in claim 1, further comprising:
selecting a plurality of COCs of different components as the raw material.
